(19) United States
(12) Patent Application Publication
(10) Pub. No.: US 2024/0143898 A1
(43) Pub. Date: May 2, 2024

(54) CONTENT TYPESETTING METHOD AND APPARATUS, COMPUTER DEVICE, AND STORAGE MEDIUM

(71) Applicant: Beijing Bytedance Network Technology Co., Ltd., Beijing (CN)

(72) Inventors: Yiyue TAO, Beijing (CN); Dan LU, Beijing (CN)

(21) Appl. No.: 18/557,261

(22) PCT Filed: Jun. 29, 2022
(86) PCT No.: PCT/CN2022/102144

§ 371 Date: Oct. 25, 2023

(30) Foreign Application Priority Data
Aug. 13, 2021 (CN) 202110928804.8

(51) Int. Cl. G06F 40/109; G06F 40/186

(52) U.S. Cl. CPC G06F 40/109; G06F 40/186

(57) ABSTRACT

Provided are a content typesetting method and apparatus, a computer device, and a storage medium. The method includes: acquiring each text element in content to be typeset as well as the element type of each text element (S101); determining rendering size information of each text element on the basis of the element type of each text element and a preset rendering size relationship between element types indicated by a movable character template (S102); and on the basis of the rendering size information of each text element and typesetting style setting information, typesetting the content to be typed (S103). The rendering size of each text element can be determined according to the element type, which avoids a process where the rendering size of each text element needs to be separately measured each time typesetting is performed, thereby improving the computation efficiency of rendering size, and improving typesetting efficiency.

### CROSS REFERENCES TO RELATED APPLICATIONS

This application claims the priority of Chinese patent application with application No. 202110928804.8, filed in China National Intellectual Property Administration on Aug. 13, 2021, with the application name of “Content Typesetting Method, Apparatus, Computer Device and Storage Medium”, the entire contents of which are incorporated into this application by reference.

### TECHNICAL FIELD

The application relates to the field of information technology, and in particular, relates to a content typesetting method, apparatus, computer device and storage medium.

### BACKGROUND

With the development of Internet technology, people's reading habits have gradually changed, and more and more users like to read books, news information and other content on terminal devices.

The typesetting speed of the read content is directly related to the user's reading experience. At present, the main typesetting method is to measure the size of each character after obtaining the read content to be typeset, and then the typesetting is performed according to the size of each character. When there are a lot of read contents, the typesetting efficiency of this typesetting method is relatively low, which causes users to wait too long.

### SUMMARY

The embodiments of the disclosure at least provide a content typesetting method, apparatus, computer device and storage medium.

In a first aspect, an embodiment of the present disclosure provides a content typesetting method, including:
obtaining respective text elements and element types of the respective text elements in a content to be typeset;
determining rendering size information of the respective text elements based on the element types of the respective text elements and a rendering size relationship between the element types indicated by a preset movable type template; and
typesetting the content to be typeset based on the rendering size information and typesetting style setting information of the respective text elements.

In an alternative embodiment, the obtaining respective text elements and element types of the respective text elements in a content to be typeset includes:
determining a plurality of content units from the content to be typeset based on a content unit indication field in the content to be typeset; wherein the plurality of content units include at least one title unit and at least one paragraph unit; and
for each content unit, in a case that a content form of the content unit is text, determining the respective text elements in the content unit and the element types of the respective text elements.

In an alternative embodiment, the determining rendering size information of the respective text elements based on the element types of the respective text elements and a rendering size relationship between the element types indicated by the preset movable type template includes:
for each content unit, determining the rendering size information of the respective text elements in the content unit based on the rendering size information corresponding to the preset element type in the content unit indicated in the typesetting style setting information, the element types of the respective text elements in the content unit, and the rendering size relationship between the element types indicated by the preset movable type template;
wherein the typesetting style setting information includes rendering size information corresponding to the preset element type in the title unit and rendering size information corresponding to the preset element type in the paragraph unit.

In an alternative embodiment, the typesetting the content to be typeset based on the rendering size information and typesetting style setting information of the respective text elements includes:
for each content unit, determining a horizontal placeholder size of the respective text elements in the content unit based on the determined rendering size information of the respective text elements in the content unit, and determining a vertical placeholder size of the respective text elements in the content unit based on a line height indicated in the typesetting style setting information;
determining respective text elements of the content unit arranged in each line based on the horizontal placeholder size of the respective text elements and the horizontal placeholder size of a whole line in the typeset page; and
typesetting the content unit on at least one typeset page according to the determined text elements arranged in each line of the content unit, the vertical placeholder size of the respective text elements, and typesetting type, paragraph spacing and line spacing indicated in the typesetting style setting information.

In an alternative embodiment, the method further comprises:
in a case that the content form of the content unit is non-text, obtaining the original size information of the non-text content unit, wherein the original size information includes height information and width information;
taking the height information as the vertical placeholder size of the non-text content unit, and configuring the horizontal placeholder size of the non-text content unit as the horizontal placeholder size of the whole line; and
typesetting the non-text content unit based on typesetting type and paragraph spacing indicated in the typesetting style setting information, and the vertical placeholder size and the horizontal placeholder size.

In an alternative embodiment, the method further comprises:
for any text element, if the element type of the any text element does not exist in the preset movable type template, taking the rendering size information of the corresponding element type with the largest rendering size among the element types existing in the preset movable type template as the rendering size information of the any text element.

In an alternative embodiment, the method further comprises:
for any text element, if the element type of the any text element does not exist in the preset movable type template, determining the size relationship between the any text element and other text elements under the element type existing in the preset movable type template based on the obtained original size information of the respective text elements to be typeset; and
based on the size relationship, updating the rendering size relationship between the special element type corresponding to the any text element and other element types in the preset movable type template.

In an alternative embodiment, before determining rendering size information of the respective text elements based on the element types of the respective text elements and a rendering size relationship between the element types indicated by the preset movable type template, the method further includes:
displaying the preset movable type template in an editable state;
obtaining an updated movable type template obtained by supplementing the preset movable type template; wherein the updated movable type template includes the rendering size relationship between the special element type that does not exist in the preset movable type template and other element types;
wherein the determining rendering size information of the respective text elements based on the element types of the respective text elements and a rendering size relationship between the element types indicated by the preset movable type template comprises:
determining the rendering size information of the respective text elements to be typeset based on the element types of the respective text elements to be typeset and the rendering size relationship between the element types indicated by the updated movable type template.

In a second aspect, the embodiment of the present disclosure also provides a content typesetting apparatus, including:
a first obtaining module, configured to obtain respective text elements and element types of the respective text elements in a content to be typeset;
a first determining module, configured to determine rendering size information of the respective text elements based on the element types of the respective text elements and a rendering size relationship between the element types indicated by a preset movable type template; and
a first typesetting module, configured to typeset the content to be typeset based on the rendering size information and typesetting style setting information of the respective text elements.

In a third aspect, the embodiment of the present disclosure also provides a computer device, which comprises a processor, a memory and a bus, wherein the memory stores machine-readable instructions executable by the processor; when the computer device is running, the processor communicates with the memory through the bus; and when the machine-readable instructions are executed by the processor, the steps in the first aspect described above or any possible implementation of the first aspect are executed.

In a fourth aspect, the embodiment of the present disclosure also provides a computer-readable storage medium, wherein a computer program is stored on the computer-readable storage medium, and when the computer program is run by a processor, the steps in the first aspect described above or any possible implementation of the first aspect are executed.

According to the content typesetting method, apparatus, computer device and storage medium provided by the embodiment of the present disclosure, the preset movable type template stores the rendering size relationship of the element types of the respective text elements, and when the preset movable type template and typesetting style setting information are adopted for typesetting, the rendering size information of the respective text elements can be determined according to the element types of the text elements, thus avoiding a process of measuring the rendering size of the respective text elements separately every time typesetting is carried out, thus improving calculation efficiency of the rendering size and further improving typesetting efficiency.

According to the content typesetting method provided by the embodiment of the present disclosure, before determining the rendering size information of the respective text elements to be typeset, the rendering size relationship between element types in the preset movable type template can be supplemented and updated, so as to improve the calculation efficiency of rendering size in the typesetting process, and further improve the typesetting efficiency.

In order to make the above objects, features and advantages of the present disclosure more obvious and easier to understand, the following is a detailed description of preferred embodiments, with the attached drawings.

### BRIEF DESCRIPTION OF THE DRAWINGS

In order to explain the technical scheme of the embodiment of the present disclosure more clearly, the following will briefly introduce the drawings needed in the embodiment, and the drawings are incorporated into and constitute a part of this specification. These drawings show the embodiment in line with the present disclosure and together with the specification, serve to explain the technical scheme of the present disclosure. It should be understood that the following drawings only show some embodiments of the present disclosure, so they should not be regarded as limiting the scope. For ordinary people in the field, other related drawings can be obtained according to these drawings without creative work.

FIG. 1 shows a flow chart of a content typesetting method provided by an embodiment of the present disclosure;

FIG. 2 shows a flowchart of another content typesetting method provided by an embodiment of the present disclosure;

FIG. 3 shows a schematic diagram of a content typesetting apparatus provided by an embodiment of the present disclosure; and

FIG. 4 shows a schematic diagram of a computer device provided by an embodiment of the present disclosure.

### DETAILED DESCRIPTION

In order to make the purpose, technical scheme and advantages of the embodiment of the disclosure clearer, the technical scheme in the embodiment of the disclosure will be described clearly and completely with the attached drawings. Obviously, the described embodiment is only a part of the embodiment of the disclosure, but not the whole embodiment. The components of the embodiments of the present disclosure generally described and illustrated in the drawings herein may be arranged and designed in various different configurations. Therefore, the following detailed description of the embodiments of the disclosure provided in the accompanying drawings is not intended to limit the scope of the claimed disclosure, but merely represents selected embodiments of the disclosure. Based on the embodiments of the present disclosure, all other embodiments obtained by those skilled in the art without creative work belong to the scope of protection of the present disclosure.

At present, the main typesetting method is to measure the size of each character after obtaining the read content to be typeset, and then perform typesetting according to the size of each character. When there are a lot of contents to be read, the typesetting efficiency of this typesetting method is low, which causes users to wait too long.

Based on this, the present disclosure provides a content typesetting method, apparatus, computer device and storage medium, wherein the method includes the following steps: obtaining respective text elements and element types of respective text elements in the content to be typeset; determining rendering size information of the respective text elements based on the element types of the respective text elements and a rendering size relationship between the element types indicated by a preset movable type template; and based on the rendering size information and typesetting style setting information of the respective text elements, typesetting the content to be typeset. When the preset movable type template and typesetting style setting information are adopted for typesetting in this disclosure, the rendering size information of the respective text elements can be determined according to the element type, thus avoiding a process of measuring the rendering size of each content element to be typeset each time separately, thus improving calculation efficiency of the rendering size and further improving typesetting efficiency.

It should be noted that similar symbols and letters indicate similar items in the following drawings, so once an item is defined in one drawing, it does not need to be further defined and explained in subsequent drawings.

In order to facilitate the understanding of this embodiment, firstly, a content typesetting method disclosed in this embodiment of the disclosure is introduced in detail. The content typesetting method provided by this embodiment of the disclosure is realized by front-end codes loaded by the client terminal. Specifically, the client terminal can provide a webview container to load the front-end codes, and the front-end code executes the content typesetting method provided by this embodiment of the disclosure at runtime.

The content typesetting method provided by the embodiment of the present disclosure is suitable for the scene of typesetting the read content when the device terminal opens a reading interface.

Next, the content typesetting method provided by the embodiment of the present disclosure will be explained by taking an execution subject as the terminal device as an example.

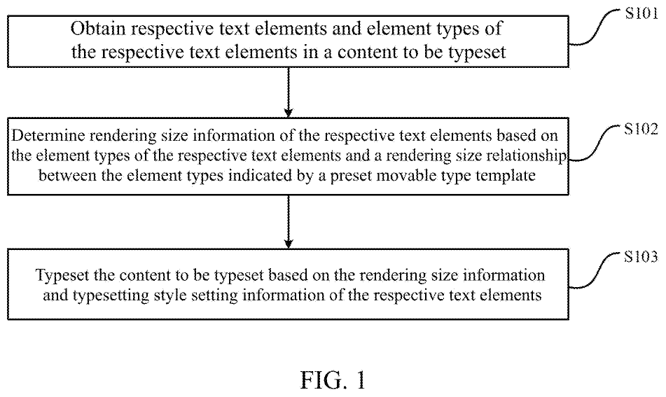

Referring to FIG. 1, which is a flowchart of a content typesetting method provided by an embodiment of the present disclosure, the method includes steps S101-S103:

S101: Respective text elements and element types of the respective text elements are obtained in a content to be typeset.

Here, the content to be typeset is a content to be typeset on a reading interface of a client terminal. When the reading interface is open, the content to be typeset may be obtained from a server; and the content to be typeset may include text content and non-text content (such as pictures, videos, etc.). In this step, the content in text form is mainly obtained, and then respective text elements in the content in text form is determined.

A text element refers to the smallest content in the content in text form, such as one character. Text elements may include character elements, number elements and symbol elements. Herein the text elements may be any language type, such as Chinese character elements, English letter elements, Greek letter elements, etc., and the letter elements may include uppercase letter elements and lowercase letter elements. Number elements may include any number elements such as Arabic number elements and Roman number elements and other number elements. Symbol elements may include punctuation elements, mathematical symbol elements, unit symbol elements, arrow symbol elements and any other special symbol elements.

In the process of typesetting, text elements with the same horizontal size can be regarded as one element type. For example, each Chinese character has a same rendered size, so the Chinese characters can be regarded as one element type.

Consider that in the process of typesetting, horizontal dimensions rendered by different text elements are not definitely the same. For example, a horizontal dimension rendered by the English letter “w” is larger than a horizontal dimension rendered by the English letter “f”, and the horizontal dimension rendered by a capital letter of the same English letter is larger than the horizontal dimension rendered by a lowercase letter. Further, considering that the number of letter elements, number elements and symbol elements in the existing text elements is limited, treating each letter (distinguishing uppercase and lowercase), each number and each symbol as one element type will not seriously increase calculation amount, but facilitate dividing the element types. Therefore, in one embodiment, each letter, each number and each symbol may be regarded as one element type, and for example, 0, 1, 2, 3, 4, 5, 6, 7, 8, 9 may be regarded as 10 element types.

As mentioned above, the content to be typeset also includes non-text content. For non-text content, one picture, one video, one component, etc. can be used as one non-text element.

In the embodiment of the present disclosure, the content to be typeset may be a complete content, such as a novel, so the content to be typeset may include a title and a paragraph. In general, the rendering sizes of titles and paragraphs are different, for example, the rendering size of text content in titles is larger than the rendering size in paragraphs. Therefore, in one embodiment, it is possible to determine a plurality of content units including at least one title unit and at least one paragraph unit from the content to be typeset based on a content unit indication field in the content to be typeset, and then determine respective text elements and element types of the respective text elements in the content unit for each content unit in a case that the content form of the content unit is text.

Herein the content unit indication field refers to field information for indicating respective content units and respective content unit types in the content to be typeset. For example, some content elements in the content to be typeset are marked with the field “content”, so the field “content” can indicate these content elements as one content unit. If the field “type ‘paragraph’” is marked at the end of a certain content unit, the field “type ‘paragraph’” can indicate that the content unit is a paragraph unit.

The content unit indication field may be marked in advance in the content to be typeset, and the content to be typeset obtained from the server may contain the content unit indication field, and the content unit contained in the content to be typeset can be determined according to the content unit indication field.

According to the content unit indication field, a plurality of text and/or non-text content units contained in the content to be typeset can be determined. And in general, a title unit in the content unit is a content unit in text form, and the paragraph unit is a content unit in text form and/or in non-text form.

After obtaining the respective text elements and the element types of the respective text elements, the process of determining the rendering size information of the respective text elements and the process of typesetting the content in text form, i.e., steps S102 and S103, can be performed in turn, and the typesetting process for the non-text content in the content to be typeset will be described in detail later.

S102: The rendering size information of the respective text elements is determined based on the element types of the respective text elements and the rendering size relationship between the element types indicated by the preset movable type template.

In the embodiment of the present disclosure, the preset movable type template may be an information template that integrates the element types of a plurality of preset text elements (not necessarily including the element types corresponding to the respective text elements in the content to be typeset) and the rendering size information of the respective element types in advance before S102 is executed. The movable type template integrates the rendering size information of various element types as much as possible, so that the rendering size information of the respective text elements to be typeset can be determined more comprehensively in actual typesetting. Here, the rendering size of each element type in the movable type template does not necessarily represent the actual rendering size information, but the rendering size of each element type in the movable type template represents a relative rendering size between respective element types, i.e., the rendering size relationship. In the actual rendering process, it is possible to render according to the rendering size information of respective element types in the movable type template, or select a target element type from the movable type template, render the text elements of the target element type with the preset rendering size information, and then determine the rendering size information of text elements of other element types according to the rendering size relationship between the target element type and other element types. Table 1 shows a movable type template.

TABLE 1

| Element type | Character | a | b | f | . . . | + | @ | % | . . . |
|---|---|---|---|---|---|---|---|---|---|
| Rendering size | 19 | 11 | 11 | 6 | . . . | 12 | 20 | 17 | . . . |

In this table, various element types and rendering size information of respective element types are shown, and the unit of rendering size is Pixel (or px for short). For example, the rendering size of the element type “Character” is 19 px, the rendering size of the element type letter “a” is 11 px, and the rendering size of the element type letter “f” is 11 px.

Through the above rendering sizes of respective element types, it can be concluded that a rendering size ratio of the element type “Character” to the element type letter “a” is 19:11, a rendering size ratio of the element type “Character” to the element type letter “f” is 19:6, and a rendering size ratio of the element type “a” to the element type “f” is 11:6, and so on.

What needs to be explained here is that in actual typesetting, it is not necessary to render according to the rendering size information of respective element types in the movable type template, but the actual rendering size information of any element type can be given, and then the actual rendering size information of other element types can be determined according to the determined rendering size relationship between any two element types, and finally rendering can be performed according to the actual rendering size information of respective element types.

For example, in the actual rendering process, when the text element of the element type “Character” is rendered with a rendering size of 19 px, it can be determined that the actual rendering size of the element type “a” is 11 px and the actual rendering size of the element type “f” is 6 px; when the text element of the element type “Character” is rendered in 39 px, it can be determined that the actual rendering size of the element type “a” is 22 px, and the actual rendering size of the element type “f” is 12 px, and so on.

As mentioned above, in the typesetting process, the rendering size of the text elements in a title unit and the text elements in a paragraph unit may be different, so here, for each content unit, the rendering size information of the respective text content elements in the content unit can be determined based on the rendering size information corresponding to the preset element type in the content unit indicated in the typesetting style setting information, the element types of the respective text elements in the content unit, and the rendering size relationship between the element types indicated by the preset movable type template; herein, the typesetting style setting information includes rendering size information corresponding to the preset element type in the title unit and rendering size information corresponding to the preset element type in the paragraph unit.

When determining the rendering size information of the respective text elements in the title unit, for example, the rendering size information corresponding to the preset element type in the title unit indicated in the typesetting style setting information is the rendering size information of the element type “Character” (which may be different from the rendering size information of the element type “Character” in the movable type template), then, according to the rendering size information of the element type “Character” in the title unit indicated in the typesetting style setting information, the text element of the element type “Character” in the title unit is rendered, and the rendering size information of other element types in the title unit is determined according to the rendering size information of the element type “Character” and the rendering size relationship between the element type “Character” in the movable type template and other element types.

Specifically, when the rendering size information indicates that the element type “Character” in the title unit in the typesetting style setting information is 24 px, and the rendering size information of the element type “Character” in the movable type template in Table 1 is 19 px, then the text element of the element type “Character” can be rendered in 24 px, and it can be determined that the rendering size information of the element type letter “a” is 24*11/19 px and the rendering size information of the element type letter “f” is 24*6/19 px according to the rendering size relationship between the element type “Character” in the movable type template in Table 1 and other element types, and so on.

The process of determining the rendering size information of the respective text elements in the paragraph unit is similar to the process of determining the rendering size information of the respective text elements in the title unit, which is not described here.

Since the typesetting style setting information contains the rendering size information corresponding to the preset element type in the title unit and the rendering size information corresponding to the preset element type in the paragraph unit, the text elements in the title unit and the paragraph unit are respectively rendered, thus realizing the diversity of content typesetting.

S103: The content to be typeset is typeset based on the rendering size information and typesetting style setting information of the respective text elements.

When typesetting the content to be typeset, it is necessary to consider not only a horizontal placeholder size of the text elements, but also a vertical placeholder size of the text elements. Herein the horizontal placeholder size refers to the size information occupied in a horizontal direction of the typeset page, and the vertical placeholder size refers to the size information occupied in a vertical direction of the typeset page.

In one embodiment, for each content unit, the horizontal placeholder size of the respective text elements in the content unit can be determined based on the determined rendering size information of the respective text elements in the content unit, and the vertical placeholder size of the respective text elements in the content unit can be determined based on a line height indicated in the typesetting style setting information; respective text elements of the content unit arranged in each line is determined based on the horizontal placeholder size of the respective text elements and the horizontal placeholder size of a whole line in the typeset page; the content unit is typeset on at least one typeset page according to the determined text elements arranged in each line of the content unit, the vertical placeholder size of the respective text elements, and typesetting type, paragraph spacing and line spacing indicated in the typesetting style setting information.

Here, the rendering size information includes width information of text elements. In the embodiment of the present disclosure, the spacing between two text elements may be zero by default, so for each content unit, the horizontal placeholder size of the respective text elements in the content unit can be determined based on the determined rendering size information of the respective text elements in the content unit.

For each text element, there can be a corresponding original width-height ratio. After the rendering size information (i.e., width information) of respective text elements is determined, the height information of the text element can be determined according to the original width-height ratio. However, for better typesetting, it is not necessary to use the height information of the text element for typesetting. For each content unit, the vertical placeholder size of the respective text elements in the content unit can be determined according to the line height indicated in the typesetting style setting information. In the same content unit, different text elements may have the same corresponding vertical placeholder size.

Further, for better typesetting effect, the vertical placeholder size can be determined according to the line height indicated in the typesetting style setting information and a preset filling spacing, herein the vertical placeholder size is equal to a sum of the line height and the preset filling spacing, and the preset filling spacing may include an upper filling spacing and a lower filling spacing. For example, according to the rendering size information (horizontal placeholder size) of the element type “Character” and the preset original width-height ratio, it is determined that the height of the element type “Character” is 14 px, the line height of the element type “Character” indicated in the typesetting style setting information is 16 px, and the preset upper filling spacing and lower filling spacing are 2 px respectively, so the vertical placeholder size of the actually rendered element type “Character” is 20 px.

Next, based on the horizontal placeholder size of the respective text elements and the horizontal placeholder size of the whole line in the typeset page, respective text elements of the content unit arranged in each line can be determined. At the end of each line, if the horizontal placeholder size is not enough to accommodate the text elements to be typeset, the text elements to be typeset can be arranged in the next line or the spacing of each typeset text element in this line can be adjusted.

Herein, a typesetting type refers to a way of switching the content, which may specifically include horizontal switching and vertical switching. The typesetting type may be preset and independent of the content unit.

For the typesetting type of horizontal switching, it involves a paging process, which may be paging according to a pre-established paging rule.

Specifically, for the typesetting type of horizontal switching, when typesetting, line typesetting and page typesetting may be performed. During the line typesetting and the page typesetting, the typeset lines and pages may be cached. Herein the line cache refers to storing the typeset text elements in the line and the line number of the line on the page. The page cache refers to the typeset text elements stored on the page, the number of the typeset lines on the page, the page number of the page, and so on.

When typesetting the text elements, for each text element to be typeset at present, it can be judged whether the text element to be typeset at present is the first text element in the paragraph where the text element is located, and if so, the text element to be typeset at present is arranged in a new line. If not, for each line, it can be judged whether the text element to be typeset will overflow in this line based on the horizontal placeholder size of the typeset text element in this line (which can be obtained from a line cache), the horizontal placeholder size of the text element to be typeset at present and the horizontal placeholder size of the whole line. If it doesn't overflow, the text element to be typeset can be arranged in this line; and if it overflows, the text element to be typeset may be arranged in a new line and the text element is line-cached.

When typesetting a text element, if the text element to be typeset at present needs to be arranged in a new line, it can be judged whether the page will overflow after the text element to be typeset at present is arranged in the new line according to the vertical placeholder information of the typeset text elements and the vertical placeholder information of the typeset page in each line. If it doesn't overflow, the text elements to be typeset may be arranged in a new line on the page; if it overflows, the text element to be typeset may be arranged in the first line of the next page, and the text element are page-cached and line-cached.

However, the typesetting type of vertical switching content does not involve the paging process, so it may be typeset only according to the rule of line arrangement, which is not repeated here.

When typesetting text elements using the movable type template, there may be element types of the text element in the movable type template. In one possible implementation, for any text element to be typeset, if there is no element type of the any text element in the preset movable type template, the rendering size information of the corresponding target element type with the largest rendering size among the element types existing in the preset movable type template may be used as the rendering size information of the any text element.

In this embodiment, usually, the rendering size information of the any text element whose element type does not exist in the preset movable type template will not exceed the rendering size information of the target element type with the largest rendering size, so when the corresponding rendering size information of the target element type with the largest rendering size is used as the rendering size information of the text element, the text element will not overflow on the typeset page and will not affect the user's impression on the typeset page.

Under special circumstances, when the rendering size information of the text element exceeds the rendering size information of the target element type with the largest rendering size, the rendering size information of the text element may be set in a customized way. Here, a preset movable type template in an editable state may be shown to the user, and then an updated movable type template i.e. created by the user customizing the movable type template may be obtained. The updated movable type template may include rendering size information of the any text element whose element type does not exist in the preset movable type template, and finally, the any text element is typeset according to the updated movable type template.

When there is no element type of the any text element in the movable type template, in one possible embodiment, the size relationship between the any text element and other content elements in the element types existing in the preset movable type template may be determined based on the original size information of the respective text elements to be typeset; and based on the size relationship, the rendering size relationship between the special element type corresponding to any text element in the preset movable type template and other element types is updated.

In this embodiment, a canvas measurement method may be used to measure the original size information of the respective text elements to be typeset, and then based on the original size information, the size relationship between the original size information of the respective text elements to be typeset may be determined, and then the size relationship between the any text element and other content elements in the element types existing in the preset movable type template may be determined. After the size relationship is determined, the rendering size relationship between the special element type corresponding to the any text element and other element types may be added to the preset movable type template, thus updating the preset movable type template.

After the movable type template is updated, the updated movable type template may be used to determine the rendering size information of the respective text elements to be typeset, so in one possible implementation, the preset movable type template in an editable state may be displayed before step S102 is executed; then an updated movable type template obtained by supplementing the preset movable type template is obtained; and the updated movable type template includes the rendering size relationship between special element types that do not exist in the preset movable type template and other element types.

The updated movable type template may be an updated movable type template obtained by the user customizing the movable type template, or an updated movable type template obtained by supplementing the preset movable type template based on the size relationship between the any text element and other text elements existing in the preset movable type template. The process of updating the movable type template is as described above. In the process of updating the movable type template, off-screen calculation and local storage may be performed at the client terminal or a webpage terminal, and the calculation process and the user's actual experience in the embodiment of the present disclosure are not affected.

Finally, based on the element types of the respective text elements to be typeset and the rendering size relationship between the element types indicated by the updated movable type template, the rendering size information of the respective text elements to be typeset may be determined. This process is the same as the process in S102, and will not be described here.

The process of typesetting the content in text form has been described above, but for the content in non-text form, i.e., in a case that the content form of the content unit is non-text, in one possible implementation, the original size information of the non-text content unit may be obtained, herein the original size information includes height information and width information; the height information is taken as the vertical placeholder size of the non-text content unit, and the horizontal placeholder size of the non-text content unit is configured as the horizontal placeholder size of the whole line; based on typesetting type and paragraph spacing indicated in the typesetting style setting information, as well as the vertical placeholder size and the horizontal placeholder size, the non-text content unit is typeset.

Herein the original size information of the non-text content unit may be obtained when the content to be typeset is obtained from the server. According to the original size information, the vertical placeholder size and the horizontal placeholder size of non-text content units may be determined, herein the horizontal placeholder size of non-text content units is configured as the horizontal placeholder size of the whole line, i.e., one non-text content unit is typeset in one line. The typesetting type here is the same as the typesetting type mentioned above, which will not be repeated here. In a specific embodiment, the non-text content unit may be typeset as one paragraph, or may be combined with the content unit in text form as one paragraph for typesetting.

Since according to the content typesetting method provided by the embodiment of the present disclosure, line-caching and page-caching may be performed on the typeset text elements, in one possible embodiment, when the content to be typeset obtained this time is completely the same as the typeset content obtained in the last typesetting, the content to be typeset this time may be typeset using the line cache and page cache in the last typesetting; when the content to be typeset obtained this time is not completely the same as the typeset content obtained in the last typesetting, the content to be typeset this time may be typeset according to the content typesetting method provided by the embodiment of the present disclosure, and the line cache and page cache in the last typesetting may be deleted, while the line cache and page cache in this time are maintained.

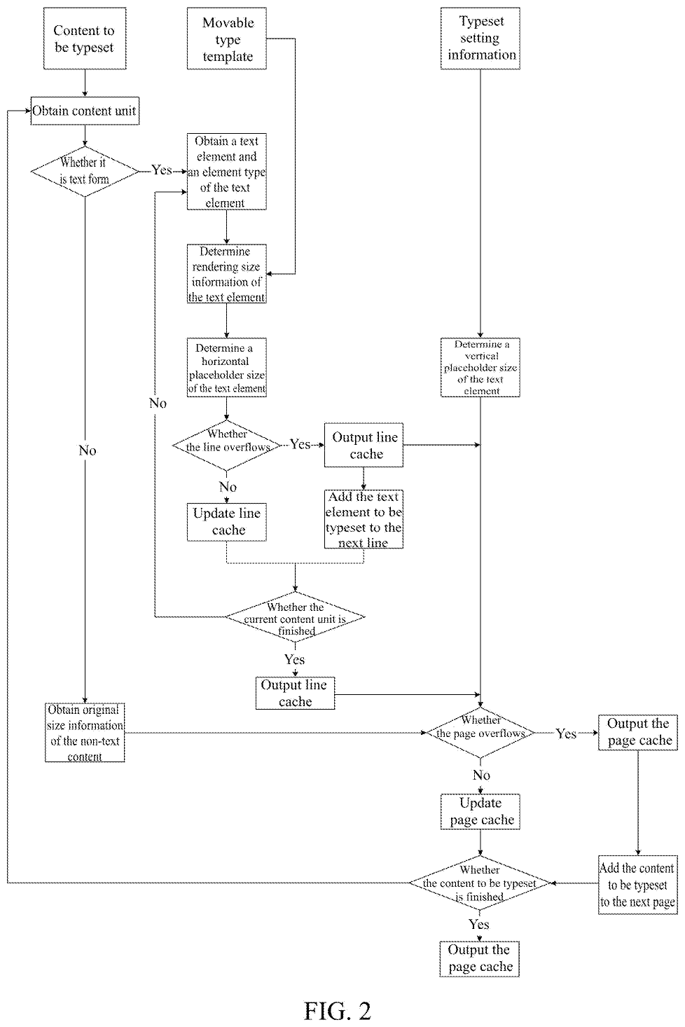

In order to explain the content typesetting method provided by the embodiment of the present disclosure in detail, the process of typesetting a novel is taken as an example to explain the content typesetting method, as shown in FIG. 2.

Here, novels to be typeset may be displayed in a client terminal's view interface. Before the method is executed, the client terminal may obtain the content to be typeset, i.e., the novel to be typeset, from the server.

According to a content unit indication field in the content to be typeset, the title unit, paragraph unit, etc., are obtained. For example, the content to be typeset includes [{content: “xxxxxx”, type: “paragraph”,}, {content: “XXXXXX”, type: “paragraph”,}], and according to the content unit indication fields “content” and “type: paragraph”, it is determined that two paragraph units are included in the typeset content.

Then, for each content unit, it is judged whether the content is in text form, and if it is determined to be in text form, the text element of the content unit and the element type of the text element are obtained. Then, according to the element types of text elements and the rendering size relationship between the element types indicated in the movable type template, the rendering size information of text elements is determined. In a case that the content unit (such as a picture) is determined as being in non-text form, the original size information of the non-text content is obtained, and the height information in the original size information is taken as the vertical placeholder size of the non-text content unit, and the horizontal placeholder size of the non-text content unit is configured as the horizontal placeholder size of the whole line.

Rendering size information of text elements refers to the width information of text elements, where the spacing between adjacent text elements is zero by default, so the horizontal placeholder size of the text elements may be determined according to the rendering size information of the text elements.

When rendering according to the horizontal placeholder size of text elements, it may be determined whether the current line overflows according to the horizontal placeholder size of the respective text elements and the horizontal placeholder size of the whole line in the typeset page. If it overflows, the typeset text elements in this line and the line number of this line are output, i.e., the line cache is output, and the text elements to be typeset are added to the next line, and it is judged whether the current content unit is finished or not; if there is no overflow, the text elements to be typeset are added to the line, and the typeset text elements in the line are updated, i.e., the line cache is updated, and it is judged whether the current content unit is finished.

In a case that the current content unit is not finished, the step of obtaining the text element of the content unit and the element type of the text element is repeatedly executed; and in a case that the current content unit is finished, it is judged whether the current page overflows according to the line cache and the vertical placeholder size of the text element determined according to the line height indicated in the typesetting setting information. In a case that the content unit includes a non-text content unit, it is judged whether the current page overflows according to the line cache, the vertical placeholder size of the text element determined according to the line height indicated in the typesetting setting information, and the vertical placeholder information of the non-text content unit.

Herein the vertical placeholder size of the text element determined according to the line height indicated in the typesetting setting information may refer to the aforementioned S103 process, which is not repeated here.

If the current page overflows, the text elements typeset in the current page, the typeset non-text content units, the number of the lines typeset in the current page and the page number of the current page are output, i.e., the page cache is output, the content to be typeset is added to the next page, and it is judged whether the typeset content is finished; if the current page does not overflow, the content to be typeset may be added to the current page, and the text elements or non-text content units typeset in the current page are updated, i.e., the page cache is updated, and it is judged whether the typeset content is finished.

In a case that the content to be typeset is not finished, the process of obtaining the content unit is repeatedly executed; in a case that the content to be typeset is finished, it means that the typesetting is finished, and the page cache may be output, so that the next time you get the same content to be typeset, typesetting may be directly performed according to the page cache.

It may be understood by those skilled in the art that in the above-mentioned method of specific embodiments, a writing order of the respective steps does not mean a strict execution order or constitute any limitation on the implementation process, and the specific execution order of the respective steps should be determined according to its function and possible internal logic.

Based on the same inventive concept, the embodiment of the present disclosure also provides a content typesetting apparatus corresponding to the content typesetting method. Since the principle of solving problems by the device in the embodiment of the present disclosure is similar to the above-mentioned content typesetting method in the embodiment of the present disclosure, the implementation of the apparatus may refer to the implementation of the method, so it is not repeated here.

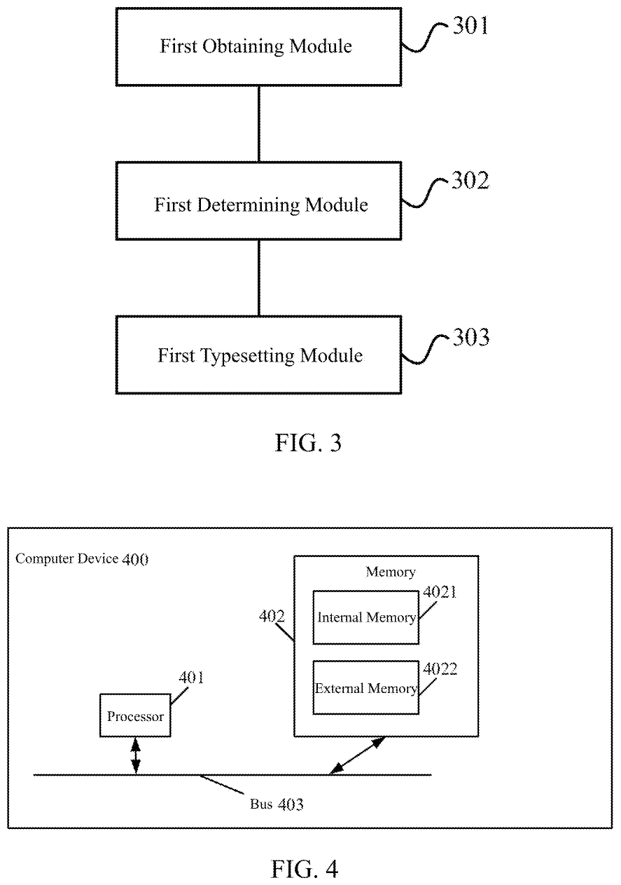

Referring to FIG. 3, a schematic architecture diagram of a content typesetting apparatus provided by an embodiment of the present disclosure includes: a first obtaining module 301, a first determining module 302, and a first typesetting module 303; wherein,
the first obtaining module 301 is configured to obtain respective text elements and element types of the respective text elements in a content to be typeset;
the first determining module 302 is configured to determine rendering size information of the respective text elements based on the element types of the respective text elements and a rendering size relationship between the element types indicated by the preset movable type template; and
the first typesetting module 303 is configured to typeset the content to be typeset based on the rendering size information and typesetting style setting information of the respective text elements.

In an optional embodiment, the first obtaining module 301 is specifically configured to:
determine a plurality of content units from the content to be typeset based on the content unit indication field in the content to be typeset; wherein the plurality of content units include at least one title unit and at least one paragraph unit; and
for each content unit, in a case that the content form of the content unit is text, the respective text elements in the content unit and the element types of the respective text elements are determined.

In an alternative embodiment, the first determining module 302 is specifically configured to:
for each content unit, the rendering size information of the respective text elements in the content unit is determined based on the rendering size information corresponding to the preset element type in the content unit indicated in the typesetting style setting information, the element types of the respective text elements in the content unit, and the rendering size relationship between the element types indicated by the preset movable type template;
wherein the typesetting style setting information includes rendering size information corresponding to the preset element type in the title unit and rendering size information corresponding to the preset element type in the paragraph unit.

In an alternative embodiment, the first typesetting module 303 is specifically configured to:
for each content unit, the horizontal placeholder size of the respective text elements in the content unit is determined based on the determined rendering size information of the respective text elements in the content unit, and the vertical placeholder size of the respective text elements in the content unit is determined based on the line height indicated in the typesetting style setting information;
the respective text elements of the content unit arranged in each line is determined based on the horizontal placeholder size of the respective text elements and the horizontal placeholder size of a whole line in the typeset page;
the content unit is typeset on at least one typeset page according to the determined text elements arranged in each line of the content unit, the vertical placeholder size of the respective text elements, and typesetting type, paragraph spacing and line spacing indicated in the typesetting style setting information.

In an alternative embodiment, the apparatus further comprises:
a second obtaining module, configured to obtain the original size information of the non-text content unit in a case that the content form of the content unit is non-text, wherein the original size information includes height information and width information;
a configuration module, configured to take the height information as the vertical placeholder size of the non-text content unit and configure the horizontal placeholder size of the non-text content unit as the horizontal placeholder size of a whole line; and
a second typesetting module, configured to typeset the non-text content unit based on typesetting type and paragraph spacing indicated in the typesetting style setting information, and the vertical placeholder size and the horizontal placeholder size.

In an alternative embodiment, the apparatus further comprises:
a storage module, configured for any text element, wherein if the element type of the any text element does not exist in the preset movable type template, the rendering size information of the corresponding element type with the largest rendering size among the element types existing in the preset movable type template is taken as the rendering size information of the any text element.

In an alternative embodiment, the apparatus further comprises:
a second determining module, configured to, if the element type of the any text element does not exist in the preset movable type template, determine the size relationship between the any text element and other text elements existing in the preset movable type template based on the obtained original size information of the respective text elements to be typeset; and
an updating module, configured to update the rendering size relationship between the special element type corresponding to the any text element and other element types in the preset movable type template based on the size relationship.

In an alternative embodiment, the apparatus further comprises:
a displaying module, configured to display the preset movable type template in an editable state;
a third obtaining module, configured to obtain the updated movable type template obtained by supplementing the preset movable type template; wherein the updated movable type template includes the rendering size relationship between the special element type that does not exist in the preset movable type template and other element types; and
a first determining module 302, specifically configured to determine the rendering size information of the respective text elements to be typeset based on the element types of the respective text elements to be typeset and the rendering size relationship between the element types indicated by the updated movable type template.

For the description of a processing flow of each module in the apparatus and the interaction flow between modules, please refer to the relevant description in the above method embodiment, so it will not be described in detail here.

Based on the same technical concept, the embodiment of the disclosure also provides a computer device. Referring to FIG. 4, which is a schematic structural diagram of a computer device 400 provided for an embodiment of the present disclosure, the computer device 400 includes a processor 401, a memory 402, and a bus 403. The memory 402 is used for storing execution instructions, including an internal memory 4021 and an external memory 4022; here, the internal memory 4021, also called internal memory, is used to temporarily store operation data in the processor 401 and the data exchanged with the external memory 4022 such as hard disk. The processor 401 exchanges data with the external memory 4022 through the internal memory 4021, and when the computer device 400 is running, the processor 401 communicates with the memory 402 through the bus 403, so that the processor 401 execute the following instructions:
obtaining respective text elements and element types of the respective text elements in a content to be typeset;
determining rendering size information of the respective text elements based on the element types of the respective text elements and a rendering size relationship between the element types indicated by the preset movable type template; and
typesetting the content to be typeset based on the rendering size information and typesetting style setting information of the respective text elements.

The embodiment of the present disclosure also provides a computer-readable storage medium, on which a computer program is stored, and when the computer program is run by a processor, the steps of the content typesetting method described in the above method embodiment are executed. Herein the storage medium may be a volatile or nonvolatile computer-readable storage medium.

The embodiment of the present disclosure also provides a computer program product, which carries program codes, and the program codes include instructions that may be used to execute the steps of the content typesetting method described in the above-mentioned method embodiment. For details, please refer to the above-mentioned method embodiment, which is not repeated here.

Herein the above computer program products may be realized by hardware, software or their combination. In one alternative embodiment, the computer program product is embodied as a computer storage medium, and in another alternative embodiment, the computer program product is embodied as a software product, such as a Software Development Kit (SDK) and the like.

It may be clearly understood by those skilled in the art that for the convenience and conciseness of description, the specific working process of the system and apparatus described above may refer to the corresponding process in the aforementioned method embodiment, so it will not be repeated here. In several embodiments provided by this disclosure, it should be understood that the disclosed systems, apparatuses and methods may be realized in other ways. The apparatus embodiments described above are only schematic. For example, division of the units is only a logical function division, and there may be another division method in actual implementation. For example, multiple units or components may be combined or integrated into another system, or some features may be ignored or not implemented. On the other hand, mutual coupling or direct coupling or communication connection shown or discussed may be indirect coupling or communication connection through some communication interfaces, apparatuses or units, which may be in electrical, mechanical or other forms.

The units described as separate components may or may not be physically separated, and the components displayed as units may or may not be physical units, i.e., they may be located in one place or distributed to multiple network units. Some or all of the units may be selected according to actual needs to achieve the purpose of this embodiment.

In addition, each functional unit in each embodiment of the present disclosure may be integrated into one processing unit, or each unit may exist physically alone, or two or more units may be integrated into one unit.

If the functions are realized in the form of software functional units and sold or used as independent products, they may be stored in a processor-executable nonvolatile computer-readable storage medium. Based on this understanding, part of the solution scheme of the disclosure that are essential or contributing to the existing technology or the technical solution may be embodied in the form of a software product, which is stored in a storage medium and includes several instructions to make a computer device (which may be a personal computer, a server, a network device, etc.) execute all or part of the steps of the method described in various embodiments of the present disclosure. The aforementioned storage media include: U disk, mobile hard disk, Read-Only Memory (ROM), Random Access Memory (RAM), magnetic disk or optical disk and other media that may store program codes.

Finally, it should be explained that the above-mentioned embodiments are only specific embodiments of the disclosure, which are used to illustrate the technical scheme of the disclosure, but not to limit it. The protection scope of the disclosure is not limited to this. Although the disclosure has been described in detail with reference to the above-mentioned embodiments, it should be understood by ordinary people in the field that any person familiar with the technical field may still modify or easily think of changes to the technical scheme recorded in the above-mentioned embodiments or substitute part of the technical features within the technical scope of the disclosure. However, these modifications, changes or substitutions do not make the essence of the corresponding technical scheme deviate from the spirit and scope of the technical scheme of the embodiment of this disclosure, and should be included in the protection scope of this disclosure. Therefore, the scope of protection of this disclosure should be based on the scope of protection of the claims.

1. A content typesetting method, comprising:
obtaining respective text elements and element types of the respective text elements in a content to be typeset;
determining rendering size information of the respective text elements based on the element types of the respective text elements and a rendering size relationship between the element types indicated by a preset movable type template; and
typesetting the content to be typeset based on the rendering size information and typesetting style setting information of the respective text elements.

2. The method according to claim 1, wherein the obtaining respective text elements and element types of the respective text elements in a content to be typeset comprises:
determining a plurality of content units from the content to be typeset based on a content unit indication field in the content to be typeset; wherein the plurality of content units include at least one title unit and at least one paragraph unit; and
for each content unit, in a case that a content form of the content unit is text, determining the respective text elements in the content unit and the element types of the respective text elements.

3. The method according to claim 2, wherein determining rendering size information of the respective text elements based on the element types of the respective text elements and a rendering size relationship between the element types indicated by the preset movable type template comprises:
for each content unit, determining the rendering size information of the respective text elements in the content unit based on the rendering size information corresponding to a preset element type in the content unit indicated in the typesetting style setting information, the element types of the respective text elements in the content unit, and the rendering size relationship between the element types indicated by the preset movable type template;
wherein the typesetting style setting information includes rendering size information corresponding to the preset element type in the title unit and rendering size information corresponding to the preset element type in the paragraph unit.

4. The method according to claim 3, wherein typesetting the content to be typeset based on the rendering size information and typesetting style setting information of the respective text elements comprises:
for each content unit, determining a horizontal placeholder size of the respective text elements in the content unit based on the determined rendering size information of the respective text elements in the content unit, and determining a vertical placeholder size of the respective text elements in the content unit based on a line height indicated in the typesetting style setting information;
determining respective text elements of the content unit arranged in each line based on the horizontal placeholder size of the respective text elements and the horizontal placeholder size of a whole line in the typeset page; and
typesetting the content unit on at least one typeset page according to the determined text elements arranged in each line of the content unit, the vertical placeholder size of the respective text elements, and typesetting type, paragraph spacing and line spacing indicated in the typesetting style setting information.

5. The method according to claim 2, further comprising:
in a case that the content form of the content unit is non-text, obtaining the original size information of the non-text content unit, wherein the original size information includes height information and width information;
taking the height information as the vertical placeholder size of the non-text content unit, and configuring the horizontal placeholder size of the non-text content unit as the horizontal placeholder size of the whole line; and
typesetting the non-text content unit based on typesetting type and paragraph spacing indicated in the typesetting style setting information, and the vertical placeholder size and the horizontal placeholder size.

6. The method according to claim 1, further comprising:
for any text element, if the element type of the any text element does not exist in the preset movable type template, taking the rendering size information of the corresponding element type with the largest rendering size among the element types existing in the preset movable type template as the rendering size information of the any text element.

7. The method according to claim 1, further comprising:
for any text element, if the element type of the any text element does not exist in the preset movable type template, determining the size relationship between the any text element and other text elements under the element type existing in the preset movable type template based on the obtained original size information of the respective text elements to be typeset; and
based on the size relationship, updating the rendering size relationship between the special element type corresponding to the any text element and other element types in the preset movable type template.

8. The method according to claim 1, before determining rendering size information of the respective text elements based on the element types of the respective text elements and a rendering size relationship between the element types indicated by the preset movable type template, the method further comprises:
displaying the preset movable type template in an editable state;
obtaining an updated movable type template obtained by supplementing the preset movable type template; wherein the updated movable type template includes the rendering size relationship between the special element type that does not exist in the preset movable type template and other element types;
wherein the determining rendering size information of the respective text elements based on the element types of the respective text elements and a rendering size relationship between the element types indicated by the preset movable type template comprises:
determining the rendering size information of the respective text elements to be typeset based on the element types of the respective text elements to be typeset and the rendering size relationship between the element types indicated by the updated movable type template.

9. (canceled)

10. A computer device, comprising a processor, a memory and a bus, wherein the memory stores machine-readable instructions executable by the processor; when the computer device is running, the processor communicates with the memory through the bus; and when the machine-readable instructions are executed by the processor, steps of a content typesetting method are executed, and the content typesetting method comprises:
obtaining respective text elements and element types of the respective text elements in a content to be typeset;
determining rendering size information of the respective text elements based on the element types of the respective text elements and a rendering size relationship between the element types indicated by a preset movable type template; and
typesetting the content to be typeset based on the rendering size information and typesetting style setting information of the respective text elements.

11. (canceled)

12. A computer program product, which, when run on a computer, causes the computer to perform a content typesetting method comprising:
obtaining respective text elements and element types of the respective text elements in a content to be typeset;
determining rendering size information of the respective text elements based on the element types of the respective text elements and a rendering size relationship between the element types indicated by a preset movable type template; and
typesetting the content to be typeset based on the rendering size information and typesetting style setting information of the respective text elements.
